(19) United States
(12) Patent Application Publication
(10) Pub. No.: US 2019/0229399 A1
(43) Pub. Date: Jul. 25, 2019

(54) ANTENNA ASSEMBLY AND MOBILE TERMINAL

(71) Applicant: AAC Technologies Pte. Ltd., Singapore City (SG)

(72) Inventors: Chao Wang, Shenzhen (CN); Xiaoyue Xia, Shenzhen (CN); Zhimin Zhu, Shenzhen (CN)

(21) Appl. No.: 16/234,561

(22) Filed: Dec. 28, 2018

(30) Foreign Application Priority Data
Jan. 25, 2018 (CN) 201810070549.6

(51) Int. Cl. H01Q 1/24; H01Q 1/42; H01Q 3/30; H01Q 21/22; H04M 1/02

(52) U.S. Cl. CPC H01Q 1/242; H01Q 1/42; H04M 1/026; H01Q 21/22; H01Q 3/30

(57) ABSTRACT

The present disclosure provides an antenna assembly, applied to a mobile terminal, and the mobile terminal includes a 3D glass housing and a PCB adhered to an inner side surface of the 3D glass housing. The antenna assembly includes a flexible circuit board that is accommodated in the 3D glass housing, a radiating antenna, and a phase shifter. The radiating antenna is attached to the flexible circuit board, the phase shifter is disposed on the PCB and is connected to the radiating antenna, and the inner side surface of the 3D glass housing faces the PCB. The present disclosure is small, and the antenna is tightly bonded with the 3D glass housing, to achieve desirable mechanical stability and prevent the antenna from being ineffective or prevent performance of the antenna from becoming poor due to that the antenna is uneasy to be damaged.

### CROSS-REFERENCE TO RELATED APPLICATIONS

This application claims the priority benefit of Chinese Patent Applications Ser. No. 201810070549.6 filed on Jan. 25, 2018, the entire content of which is incorporated herein by reference.

### TECHNICAL FIELD

The present disclosure relates to antenna technologies, and in particular, to an antenna assembly and a mobile terminal.

### BACKGROUND

In a wireless communication device, there is always an apparatus radiating electromagnetic energy to space and receiving electromagnetic energy from space, and the apparatus is an antenna. A function of the antenna is transmitting, to a spatial radio channel, a digital signal or an analog signal that is modulated to a radio-frequency frequency or receiving, from a spatial radio channel, a digital or an analog signal modulated to a radio-frequency frequency.

5G is a research and development focus in the industry of the world, and development of 5G technologies and setting of 5G standards have become a consensus of the industry. The International Telecommunication Union ITU defines main application scenarios of 5G on the 22^{nd} conference hold by ITU-RWPSD in June 2015. The ITU defines three main application scenarios: enhanced mobile broadband, massive machine type communications, and ultra-reliable and low-latency communications. The three application scenarios respectively correspond to different key indicators. In the scenario of enhanced mobile broadband, a user peak rate is 20 Gbps, and a lowest user experience rate is 100 Mbps. To achieve these strict indicators, multiple key technologies are adopted and include a millimeter wave technology.

Abundant bandwidth resources in a frequency band of the millimeter wave ensure the high transmission rate. However, due to severe space loss of an electromagnetic wave in the frequency band, a wireless communication system using the frequency band of the millimeter wave requires a phased array architecture. Phases of array elements are distributed according to a particular rule by using a phase shifter, so that a high-gain beam is formed, and the beam is enabled, through a phase shift change, to scan within a particular space.

A mobile terminal structure using 3D glass is a mainstream in the future because the 3D glass has features such as lightness and thinness, fingerprint resistance, weather resistance, and excellent touch feeling. In addition, in the future, a metal housing having a shielding effect is given up in technologies such as a wireless charging technology and a 5G millimeter wave antenna technology, and the 3D glass having excellent physical performance becomes a preferred option.

Therefore, it is necessary to provide a novel antenna assembly to resolve the foregoing problem.

### BRIEF DESCRIPTION OF THE DRAWINGS

To describe the technical solutions in the embodiments of the present disclosure more clearly, the following briefly describes the accompanying drawings required for describing the embodiments. Apparently, the accompanying drawings in the following description merely show some embodiments of the present disclosure, and persons of ordinary skill in the art can derive other drawings from these accompanying drawings without creative efforts.

FIG. 1 is a three-dimensional exploded view of a mobile terminal according to the present disclosure;

FIG. 2 is a schematic structural diagram of an antenna assembly according to the present disclosure;

FIG. 3 is a schematic diagram of coverage of an antenna assembly in a case of equi-amplitude in-phase feeding of each antenna element according to the present disclosure;

FIG. 4 is a schematic diagram of coverage of an antenna assembly when a phase difference of each antenna element is 90° according to the present disclosure;

FIG. 5 is a diagram of an overall scanning mode of an antenna assembly according to the present disclosure; and

FIG. 6 is a diagram of coverage of an antenna assembly according to the present disclosure.

### DETAILED DESCRIPTION

The following clearly and completely describes the technical solutions in the embodiments of the present disclosure with reference to the accompanying drawings in the embodiments of the present disclosure. Apparently, the described embodiments are merely a part rather than all of the embodiments of the present disclosure. All other embodiments obtained by a person skilled in the art based on the embodiments of the present disclosure without creative efforts shall fall within the protection scope of the present disclosure.

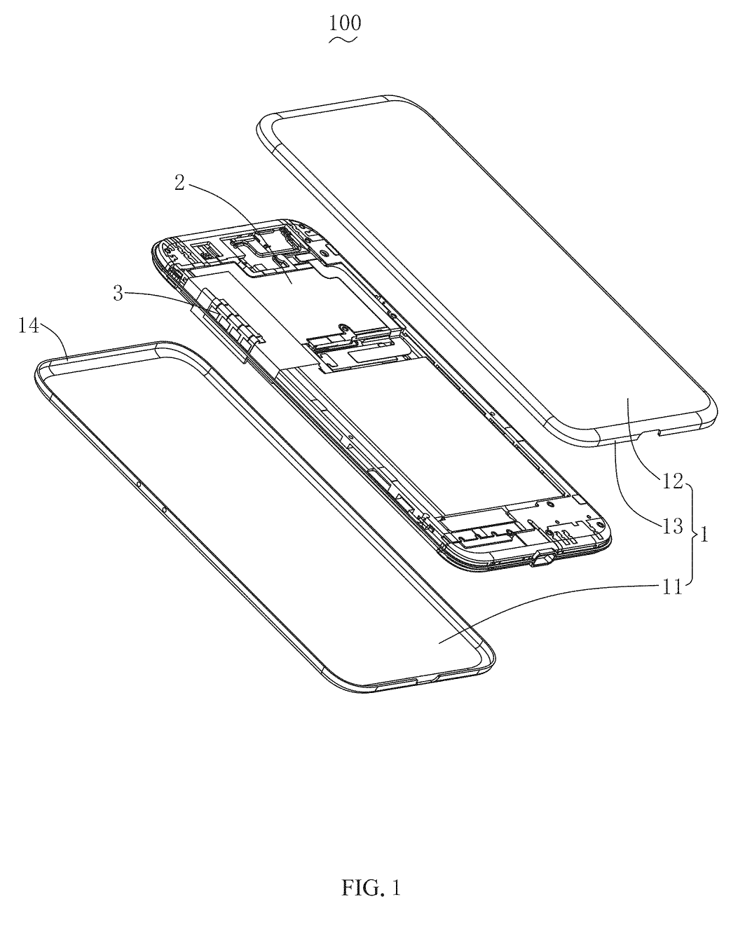

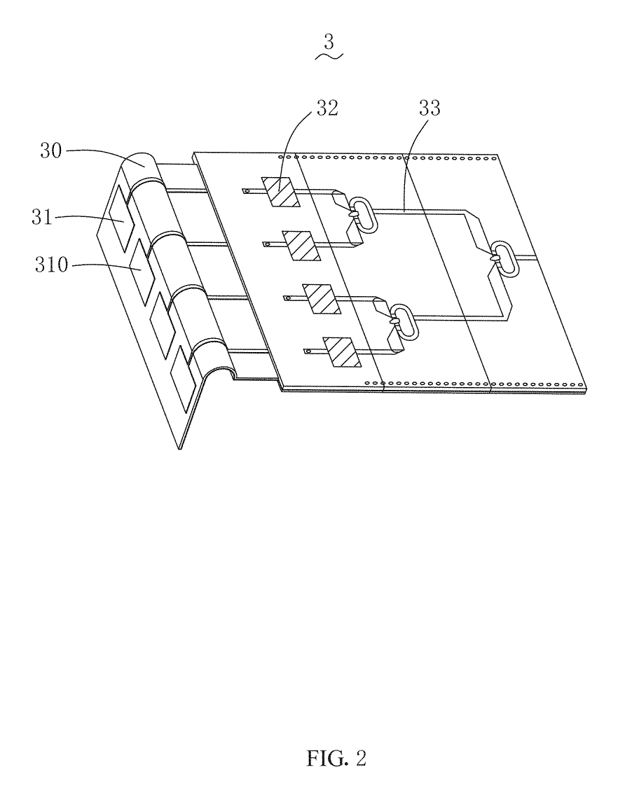

Referring to FIG. 1 and FIG. 2, an embodiment of the present disclosure provides a mobile terminal 100, for example, a mobile phone. The mobile terminal 100 includes a 3D glass housing 1, and a PCB 2 and an antenna assembly 3 that are accommodated in the 3D glass housing 1.

The 3D glass housing 1 may be a curve glass screen, and includes a screen surface 11, a rear housing surface 12 opposite to the screen surface 11, and a side wall 13 between the screen surface 11 and the rear housing surface 12. The 3D glass housing 1 is made of glass, and can reduce, as much as possible, impact on an electromagnetic wave radiated by the antenna assembly 3, to reduce space loss of the electromagnetic wave.

Referring to FIG. 1 and FIG. 2 together, the antenna assembly 3 includes a flexible circuit board 30 that is adhered to an inner side surface 14 of the 3D glass housing 1, a radiating antenna 31, and a phase shifter 32, and the inner side surface 14 of the 3D glass housing 1 faces the PCB 2. The radiating antenna 31 is an array antenna, is configured to receive and radiate the electromagnetic wave, and is attached to the flexible circuit board 30, to bend with the flexible circuit board 30, thereby implementing tight attachment between the radiating antenna 31 and the 3D glass housing 1. One end of the flexible circuit board 30 is combined with and fastened to the PCB 2, and the other end bends to be tightly attached to the inner side surface of the 3D glass housing 1. In a preferred embodiment of the present disclosure, the radiating antenna 31 is a millimeter wave antenna, so that the antenna assembly 3 has a higher signal transmission rate.

The radiating antenna 31 is tightly attached to the inner side surface of the 3D glass housing 1 by using the flexible circuit board 30. In a specific embodiment of the present disclosure, the radiating antenna 31 is attached to an inner side surface of the side wall 11. The radiating antenna is placed on the side wall, to reduce impact of a metal body in the mobile terminal 100 on radiation performance of the radiating antenna 31, thereby reducing space loss of the electromagnetic wave.

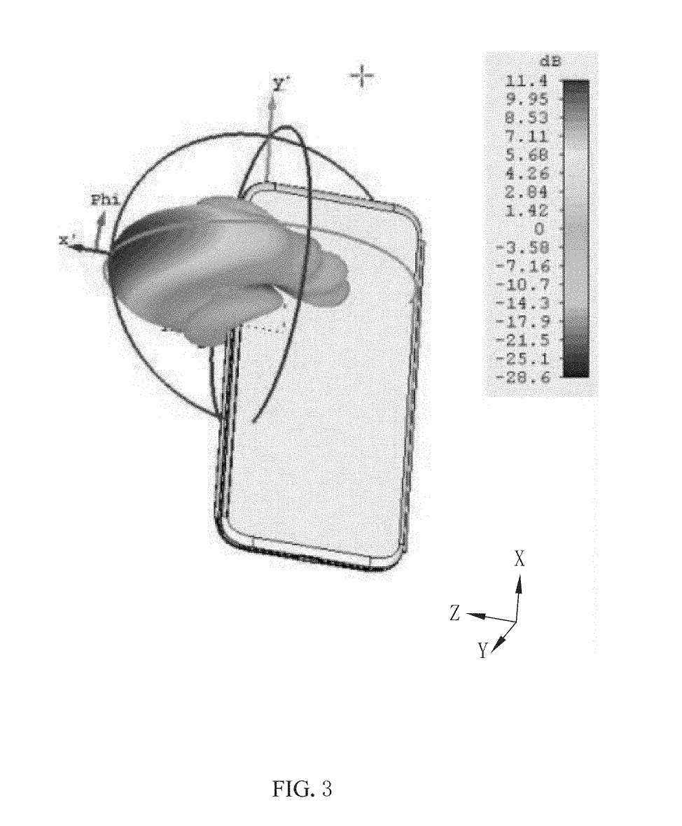

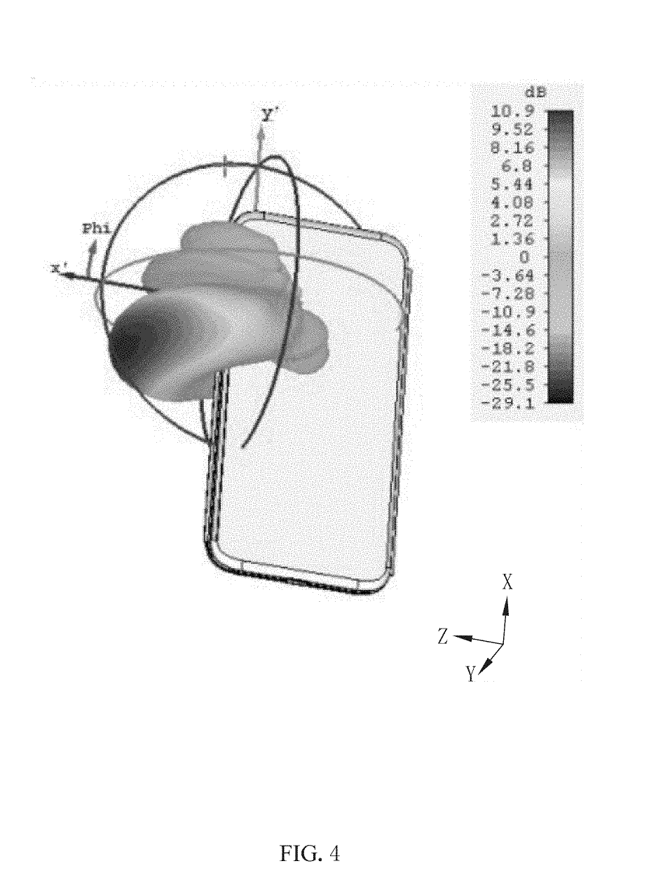

The radiating antenna 31 includes a plurality of radiating elements 310, and the plurality of radiating elements 310 are disposed in an array in a peripheral direction of the side wall 13. In a specific embodiment of the present disclosure, there are four radiating elements 310. Correspondingly, there are four phase shifters 32. Each radiating element 310 is connected to one of the phase shifters 32. Phases of the four radiating elements 310 are distributed according to a rule through control of the phase shifters 32, so that a high-gain beam is formed. In addition, the beam is enabled, through a phase shift change, to scan within a particular space, as shown in FIG. 3 and FIG. 4.

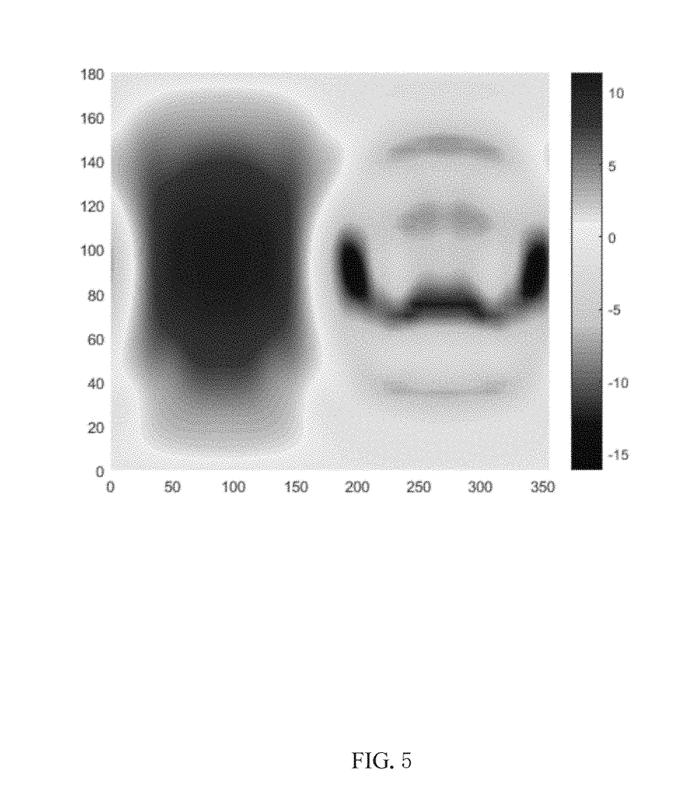

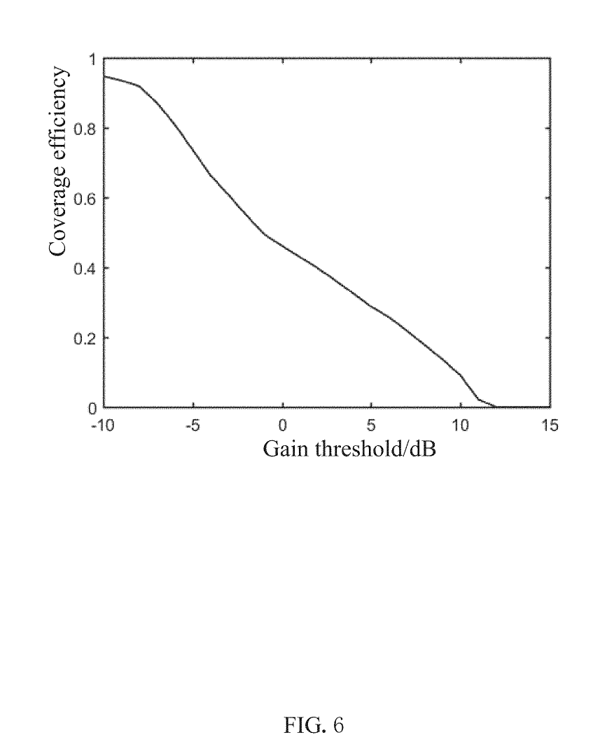

The antenna assembly 3 further includes a feeding network 33 and a control circuit (not shown in the figure) that are electrically connected to the phase shifter 32. The phase shifter 32, the feeding network, and the control circuit are all disposed on the PCB 2, to implement integrity with a mainboard in the mobile terminal 100. The phase shifter 32 is a 5-bit phase shifter with a precision of 11.25°, and is connected to the radiating antenna 31. A direction of an electromagnetic wave beam radiated by the radiating antenna 31 is changed through the change of the phase shift of the phase shifter 32. As shown in FIG. 5 and FIG. 6, the antenna assembly 3 can achieve beam coverage within a relatively wider range through beam scanning.

Compared with the related art, the antenna assembly 3 provided in the present disclosure has the following beneficial effects:

(1) The feeding network, the phase shifter, and the control circuit are disposed on the PCB 2, to implement integrity with a mainboard.

(2) The radiating antenna 31 is attached to the flexible circuit board 30 and is easy to bend, to implement tight attachment between the radiating antenna 31 and the 3D glass housing 1.

(3) The radiating antenna 31 is placed on the side wall 11, to reduce impact of a metal body in the mobile terminal 100 on radiation performance of the radiating antenna 31, thereby reducing space loss of an electromagnetic wave.

(4) The radiating antenna 31 is placed on the flexible circuit board 30, while the feeding network 33, the phase shifter 32, and the control circuit are disposed on the PCB 2, to greatly decrease an overall size of the radiating antenna 31 while fully utilizing inner space of the mobile terminal 100.

(5) The flexible circuit board 30 is used to implement tight attachment between the radiating antenna 31 and the 3D glass housing 1. Not only the radiation performance of the radiating antenna 31 is not affected, but also pattern distortion caused by air existing between the 3D glass housing 1 and the radiating antenna 31 is avoided.

(6) The radiating antenna 31 is tightly attached to the inner side surface of the 3D glass housing 1 by using the flexible circuit board 30, so that the antenna assembly 3 has better mechanical stability, and damage or ineffectiveness of the radiating antenna 31 or lowering of radiation performance due to factors of falling or shock is avoided.

The foregoing is merely embodiments of the present disclosure. It should be noted herein that a person of ordinary skill in the art may further make improvements without departing from the creative concept of the present disclosure, but these all fall within the protection scope of the present disclosure.

What is claimed is:

1. An antenna assembly, applied to a mobile terminal, the mobile terminal comprising a 3D glass housing and a PCB accommodated in the 3D glass housing;
wherein the antenna assembly comprises:
a flexible circuit board that is adhered to an inner side surface of the 3D glass housing;
a radiating antenna; and
a phase shifter;
the radiating antenna is attached to the flexible circuit board, the phase shifter is disposed on the PCB and is connected to the radiating antenna, and the inner side surface of the 3D glass housing faces the PCB.

2. The antenna assembly according to claim 1, wherein the 3D glass housing comprises a screen surface, a rear housing surface opposite to the screen surface, and a side wall between the screen surface and the rear housing surface, and the radiating antenna is tightly attached to the side wall by using the flexible circuit board.

3. The antenna assembly according to claim 2, wherein the radiating antenna is an array antenna and comprises a plurality of radiating elements, wherein the plurality of radiating elements are disposed in a peripheral direction of the side wall.

4. The antenna assembly according to claim 2, wherein the radiating antenna is a millimeter wave antenna.

5. The antenna assembly according to claim 3, wherein the radiating antenna is a millimeter wave antenna.

6. The antenna assembly according to claim 1, wherein the phase shifter is a 5-bit phase shifter, and precision of the phase shifter is 11.25°.

7. The antenna assembly according to claim 1, wherein the antenna assembly further comprises a feeding network and a control circuit that are electrically connected to the phase shifter, and the feeding network and the control circuit are both disposed on the PCB.

8. A mobile terminal, comprising the antenna assembly according to claim 1.

9. A mobile terminal, comprising the antenna assembly according to claim 2.

10. A mobile terminal, comprising the antenna assembly according to claim 3.

11. A mobile terminal, comprising the antenna assembly according to claim 4.

12. A mobile terminal, comprising the antenna assembly according to claim 5.

13. A mobile terminal, comprising the antenna assembly according to claim 6.
